(19) United States
(12) Patent Application Publication
(10) Pub. No.: US 2013/0069014 A1
(43) Pub. Date: Mar. 21, 2013

(54) CONDUCTIVE PASTE COMPOSITION FOR LOW TEMPERATURE FIRING

(71) Applicants: Young Il Lee, Gyunggi-do (KR); Dong Hoon Kim, Gyunggi-do (KR); Jun Young Kim, Seoul (KR); Ji Han Kwon, Seoul (KR); Sung Eun Kim, Seoul (KR)

(72) Inventors: Young Il Lee, Gyunggi-do (KR); Dong Hoon Kim, Gyunggi-do (KR); Jun Young Kim, Seoul (KR); Ji Han Kwon, Seoul (KR); Sung Eun Kim, Seoul (KR)

(73) Assignee: SAMSUNG ELECTRO-MECHANICS CO., LTD., Gyunggi-do (KR)

(21) Appl. No.: 13/333,801

(22) Filed: Dec. 21, 2011

(30) Foreign Application Priority Data
Sep. 21, 2011 (KR) 1020110094964

(51) Int. Cl. H01B 1/22; B82Y 99/00

(52) U.S. Cl. 252/512; 977/779

(57) ABSTRACT

Disclosed is a conductive paste composition for low temperature firing, including conductive copper powder composed of flake powder, spherical powder and nano powder, a melamine-based binder, and an organic solvent, thus enabling the formation of a conductive wire having a high aspect ratio with high printability, and inexpensive formation of a metal wire, and exhibiting superior electrical properties and adhesive force even when conducting low temperature firing at 200° C. or less, so that the conductive paste composition can be usefully applied as a conductive material for forming electrodes of a variety of products such as solar cells, touch panels, printed circuit boards (PCBs), radio-frequency identification (RFID), plasma display panels (PDPs) and so on.

### CROSS REFERENCE TO RELATED APPLICATION

This application claims the benefit of Korean Patent Application No. 10˜2011˜0094964, filed Sep. 21, 2011, entitled “Conductive paste composition for low temperature firing,” which is hereby incorporated by reference in its entirety into this application.

### BACKGROUND OF THE INVENTION

1. Technical Field

The present invention relates to a conductive paste composition for low temperature firing.

2. Description of the Related Art

The recent demand for low cost and low temperature firing for electrodes for printed circuit boards (PCBs), radio-frequency identification (RFID), touch panels, plasma display panels (PDPs), solar cells, etc., is increasing, and thus attention is being paid to an inexpensive conductive paste having superior electrical properties even when conducting low temperature firing.

Although a conductive paste composed mainly of silver has been conventionally used, silver is an expensive precious metal with which it is difficult to satisfy the requirement of low cost. Hence, attempts have been made to use materials such as aluminum, zinc, copper, etc., which are lower-priced, in lieu of silver, but it is difficult to apply these materials because of low oxidation stability and high resistance upon low temperature firing.

For example, Korean Patent Publication No. 2011˜0033770 discloses a conductive paste for low temperature firing composed of zinc powder and an organic binder, but the actual low temperature firing temperature is high to the extent of about 480° C., and the resultant resistivity is as high as 50˜300 μΩ·cm, making it difficult to apply it to electrode materials for low temperature firing.

Also Korean Patent Publication No. 2005˜0104357 discloses a conductive paste composed of spherical and flake copper powder coated with silver using plating, instead of expensive silver powder, and phenol and epoxy resins, wherein upon heat treatment at 170˜200° C., high adhesive force may be exhibited but a very high resistivity of 100˜1000 μΩ·cm may result, making it unsuitable for use as an electrode material that attains superior electrical properties when conducting low temperature firing.

Meanwhile, Korean Patent Publication No. 2010˜0108098 discloses a paste for low temperature firing, composed of micrometer-sized silver having metal nanoparticles grafted onto the surface thereof or silver-coated copper flake particles. However, when such flake particles are applied not to silver but to copper, the amount of the nanoparticles grafted onto the surface thereof is small, making it difficult to obtain good electrical properties upon low temperature firing.

Also, Japanese Patent Publication No. 2005˜251542 discloses a method of preparing a conductive silver paste composed of an epoxy resin, flake silver powder, and 20 nm or smaller nano silver powder coated with an organic material. However, it is difficult for the composition including flake powder and nano powder to increase the filling density of a metal wire by itself. Even when such a powder composition is embodied using copper, limitations are imposed on attaining good electrical properties when conducting low temperature firing.

### SUMMARY OF THE INVENTION

Therefore, the present inventors have discovered that when a conductive paste composed of conductive copper powder having optimal diameter, shape and composition ratio and a melamine-based binder as a main organic binder is provided, a wire having a high aspect ratio may be formed, the cost thereof may be decreased compared to a conventional conductive paste composed mainly of silver powder, firing is possible even at a low temperature of 200° C. or less, and superior electrical properties and adhesive force may be exhibited, thereby culminating in the present invention.

Accordingly, an aspect of the present invention is to provide a conductive paste composition for low temperature firing, which may manifest high aspect ratio, superior electrical properties, and high adhesive force.

In order to accomplish the above aspect, the present invention provides a conductive paste composition for low temperature firing, comprising conductive copper powder comprising flake powder, spherical powder and nano powder, a melamine-based binder, and an organic solvent.

In an embodiment of the present invention, the composition may comprise 50˜95 wt % of the conductive copper powder, 0.01˜5 wt % of the melamine-based binder, and a remainder of organic solvent.

In another embodiment of the present invention, the conductive copper powder may comprise flake powder having a size of 1˜20 μm, spherical powder having a size of 0.1˜5 μm, and nano powder having a size of 1˜100 nm.

In another embodiment of the present invention, the conductive copper powder may comprise 30˜90 wt % of the flake powder, 5˜60 wt % of the spherical powder, and 1˜30 wt % of the nano powder.

In another embodiment of the present invention, the ratio of long diameter to short diameter of the flake powder may be 1.5˜10.

In another embodiment of the present invention, the surface of the nano powder may be coated with one or more selected from the group consisting of fatty acid-, amine-, alcohol-, thiol- and polymer-based dispersants.

In another embodiment of the present invention, the melamine-based binder may be one or more selected from the group consisting of methylated melamine, methylated imino melamine, butylated melamine, butylated imino melamine, isobutylated melamine, methyl-butyl mixed melamine, hexamethoxymethyl melamine and urea melamine resin.

In another embodiment of the present invention, the composition may further comprise 0.01˜10 wt % of a cellulose-based binder.

In another embodiment of the present invention, the cellulose-based binder may be one or more selected from the group consisting of ethyl cellulose, methyl cellulose, propyl cellulose, nitro cellulose, acetic acid cellulose, propionic acid cellulose, hydroxyethyl cellulose, hydroxypropyl cellulose, and hydroxyethylhydroxypropyl cellulose.

In another embodiment of the present invention, the composition may further comprise 0.01˜10 wt % of an acrylic binder.

In another embodiment of the present invention, the acrylic binder may be one or more selected from the group consisting of polymethylmethacrylate, ethylhexylmethacrylate, cyclohexylmethacrylate, and butylacrylate.

In another embodiment of the present invention, the organic solvent may be one or more selected from the group consisting of terpineol, dihydroterpineol, ethyl carbitol, butyl carbitol, dihydroterpineol acetate, ethyl carbitol acetate, and butyl carbitol acetate.

In another embodiment of the present invention, the composition may further comprise one or more selected from the group consisting of a plasticizer, a thickener, a dispersant, a thixotropic agent, and a defoaming agent.

In another embodiment of the present invention, the composition may be a conductive material for forming an electrode of a solar cell, a touch panel, PCB, RFID, or PDP.

In another embodiment of the present invention, the electrode may be formed using screen printing, gravure printing, dispenser printing, ink-jet printing, dip coating, or spray coating.

In another embodiment of the present invention, the composition may be fired in a temperature range of 100˜200° C.

### BRIEF DESCRIPTION OF THE DRAWING

FIG. 1 is a schematic view showing a composition of copper paste particles for low temperature firing according to the present invention.

### DESCRIPTION OF SPECIFIC EMBODIMENTS

Hereinafter, embodiments of the present invention will be described in detail.

According to the present invention, a conductive paste composition is composed essentially of conductive copper powder, a melamine-based binder, and a solvent, wherein the diameter, shape and composition ratio of the copper powder in the paste are optimized, thus enabling the formation of a wire having a high aspect ratio and exhibiting superior electrical properties even after receiving low temperature firing at 200° C. or less.

In the present invention, metal powder may include copper powder having a variety of diameters and shapes as a conductive filler. With the goal of achieving superior electrical properties using a conductive paste for low temperature firing, the diameter, particle size, shape and amount of the conductive powder are adjusted to thus ensure a high rate of filling of the particles, and simultaneously high printability should also be ensured. Hence, it is important to adjust the conductive powder.

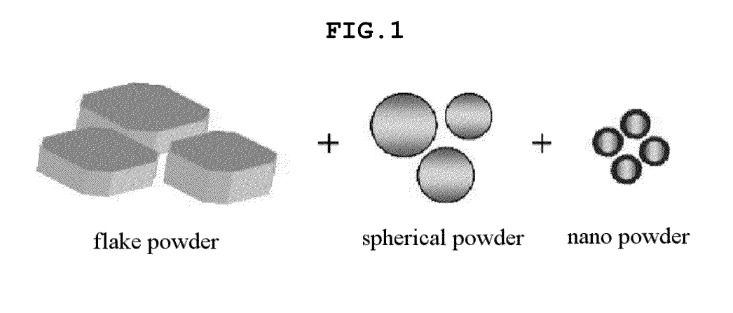

In order to obtain superior electrical properties and printability in the present invention, a copper powder mixture comprising flake copper powder having a size of 1˜20 μm, spherical copper powder having a size of 0.1˜5 μm, and nano copper powder having a size of 100 nm or less, particularly 1˜100 nm is used. FIG. 1 schematically shows the composition of the copper paste particles for low temperature firing according to the present invention.

In the present invention, the flake powder which is backbone particles is favorable in terms of increasing conductivity because the contact area of the particles is enlarged, and may increase the thixotropic index (TI) of the paste thereby forming a metal wire having a high aspect ratio even when a printing process is conducted once. Hence, the size of the flake powder may be 1˜20 μm. If the size of the flake powder is less than 1 μm, it is difficult to expect the effects of flake powder as above. In contrast, if the size thereof exceeds 20 μm, dispersibility in the paste may decrease, and printability may deteriorate because of clogging of the meshes of a screen.

Also, the ratio of the long diameter to the short diameter of the flake powder may be 1.5˜10. If the ratio of the long to the short diameter is less than 1.5, the resultant shape is close to a spherical shape, and the effects of the flake shape as above may be only slightly exhibited. In contrast, if the ratio of the long to the short diameter exceeds 10, filling properties and dispersibility may deteriorate.

The amount of the flake powder in the paste may be 30˜90 wt %. If the amount thereof is less than 30 wt %, it is difficult to improve conductivity and form a wire having a high aspect ratio even when flake powder is added. In contrast, if the amount thereof exceeds 90 wt %, dispersibility and printability may decrease, and the filling rate may be lowered, making it difficult to increase electrical properties.

In the present invention, the spherical powder has high dispersibility and is thus favorable in terms of achieving a fine line width upon printing, and is effectively charged in the empty spaces between the flake powder particles, thereby increasing the metal filling rate of the paste. When the filling rate is increased, inner spaces may decrease after firing, and shrinkage may also be prevented, thus obtaining high conductivity. Hence, the size of the spherical powder may be 0.1˜5 μm. If the size of the spherical powder is smaller than 0.1 μm, filling properties may deteriorate. In contrast, if the size thereof exceeds 5 μm, the contact area may decrease, undesirably deteriorating electrical properties.

The amount of the spherical powder in the paste may be 5˜60 wt %. If the amount thereof is less than 5 wt %, the spaces between the flake powder particles are not sufficiently filled. In contrast, if the amount thereof exceeds 60 wt %, the wire thickness may decrease, and the contact area between the particles may be reduced, undesirably deteriorating electrical properties.

In the present invention, in the case of the nano powder, fusion and metallization are possible even at low temperature because of nano-size effects. The nano powder is first dissolved between the flake backbone powder having a relatively large size and the spherical powder and may wrap them to thus increase connectivity between the particles, thereby improving conductivity. Hence, the size of the nano powder may be 100 nm or less, particularly 1˜100 nm. The nano powder less than 1 nm may decrease workability, whereas powder exceeding 100 nm makes it difficult to expect the conductivity to be improved by low temperature firing effects.

The amount of the nano powder in the paste may be 1˜30 wt %. If the amount thereof exceeds 30 wt %, the viscosity of the paste may be increased due to the large specific surface area of nano powder, and the wire thickness may decrease due to shrinkage after firing, and cracking may also occur, undesirably deteriorating electrical properties. In contrast, if the amount thereof is less than 1 wt %, almost no additional effects are gained.

Furthermore, the surface of the nano powder may be coated with one or more selected from the group consisting of fatty acid-, amine-, alcohol-, thiol- and polymer-based dispersants. The case of nano powder coated with a dispersant is advantageous because the dispersion of nano powder is facilitated, but only the surface coated nano powder is not used. Alternatively, nano powder the surface of which is not coated may be applied, depending on the size of nano powder (in the case of nano powder of 50 nm or less, nano powder coated with a dispersant may be used to increase dispersibility) and the composition of the organic binder or the organic solvent of the paste.

For example, the fatty acid-based dispersant may include but is not limited to linear or branched C6-C22 saturated fatty acids or unsaturated fatty acids, which may be used alone or in combinations of two or more, and the amine-based dispersant may include but is not limited to linear or branched C6-C22 aliphatic amines, which may be used alone or in combinations of two or more. Also, the alcohol-based dispersant may include but is not limited to higher alcohol sulfuric acid ester, alkanol amide, glycerin, sorbitan and sorbitan ester, fatty acid diethanol amine, etc., and the thiol-based dispersant may include but is not limited to ethanethiol, methanethiol, propanethiol, butanethiol, mercaptoethanol, etc. The polymer-based dispersant may include but is not limited to polyvinylpyrrolidone, polyvinylbutyral, carboxymethylcellulose, and/or polyacrylic acid.

Also in the present invention, the melamine-based binder is used as the organic binder thus exhibiting superior adhesive force even upon low temperature firing. The melamine-based binder usable in the present invention may be one or more selected from the group consisting of methylated melamine, methylated imino melamine, butylated melamine, butylated imino melamine, isobutylated melamine, methyl-butyl mixed melamine, hexamethoxymethyl melamine and urea melamine resin. Such a melamine resin may cause self-condensation and thermal curing in the temperature range of 100˜200° C. without the use of an additional curing agent, and may accelerate the packing of copper powder during firing thus increasing electrical properties.

Curing agents and catalysts necessary for curing in other thermosetting resins such as epoxy resin or phenol resin are mostly incompatible or slightly compatible with a cellulose-based binder, and thus may deteriorate the dispersibility and stability of the paste when they are used in combination. The melamine-based binder used in the present invention may exhibit superior dispersibility and stability when used together with a cellulose-based binder without the need for a curing agent and a catalyst. The cured melamine resin has a high hardness and great adhesive force and thus may manifest superior adhesive force on a variety of substrates, such as polyimide, silicone, indium tin oxide (ITO), etc.

The conductive paste composition according to the present invention may further include 0.01˜10 wt % of a cellulose-based binder, in addition to the melamine-based binder. The cellulose-based binder imparts thixotropy to the paste to facilitate the printing process, and examples thereof include a variety of cellulose resins, including ethyl cellulose, methyl cellulose, propyl cellulose, nitro cellulose, acetic acid cellulose, propionic acid cellulose, hydroxyethyl cellulose, hydroxypropyl cellulose, hydroxyethylhydroxypropyl cellulose, etc., which may be used alone or in mixtures of two or more. If the amount of the cellulose-based binder is less than 0.01 wt %, there are almost no additional effects. In contrast, if the amount thereof exceeds 10 wt %, the viscosity may increase undesirably decreasing printing workability and deteriorating electrical properties.

In the case where 0.01˜10 wt % of an acrylic binder is additionally used, as well as the melamine- and cellulose-based binders, the adhesive force may be further enhanced. Examples of the acrylic binder include but are not limited to a variety of acryl resins, including polymethylmethacrylate, ethylhexylmethacrylate, butylacrylate, cyclohexylmethacrylate, etc., which may be used alone or in mixtures of two or more. If the amount of the acrylic binder is less than 0.01 wt %, almost no additional effects are gained. In contrast, if the amount thereof exceeds 10 wt %, the viscosity may increase undesirably decreasing printing workability and deteriorating electrical properties.

In the present invention, examples of the organic solvent include a variety of organic solvents, including terpineol, dihydroterpineol, ethyl carbitol, butyl carbitol, dihydroterpineol acetate, ethyl carbitol acetate, butyl carbitol acetate, etc., which may be used alone or in mixtures of two or more.

In order to increase printability, dispersibility, stability, etc., of the conductive paste, in addition to the above components, a plasticizer such as dioctylphthalate, a dispersant such as higher fatty acid, aliphatic amine salt or alkyl phosphoric acid ester, a thickener and a thixotropic agent such as silica, bentonite, calcium carbonate, wax or polyethylene acetate, a defoaming agent such as polysiloxane, silicone, etc., may be used alone or in mixtures of two or more.

The conductive paste composition according to the present invention may be printed using a process, such as screen printing, gravure printing, dispenser printing, ink-jet printing, dip coating, or spray coating, to form an electrode. Furthermore, the composition thus printed may be fired in the temperature range of 100˜200° C.

The conductive paste composition according to the present invention may exhibit superior resistivity, contact resistance, aspect ratio and adhesive force even when conducting low temperature firing and is thus very suitable for use as a conductive material for an electrode of a solar cell and also may be efficiently applied to electrodes for wires of touch panels, PCBs, RFID and PDPs, in addition to the solar cell.

The following examples are set forth to illustrate but are not to be construed as limiting the present invention.

### Examples 1˜5

The components shown in Table 1 below were mixed and dispersed using a 3-roll kneader thus preparing a conductive paste, after which the paste was printed in a line width of about 100 μm on a silicon wafer for a solar cell using a screen printer and then fired at about 200° C. for 1 hour in a reduction atmosphere, followed by evaluating resistivity, contact resistance, aspect ratio and adhesive force. The results are shown in Table 1 below.

TABLE 1

| | | | Ex. 1 | Ex. 2 | Ex. 3 | Ex. 4 | Ex. 5 |
|---|---|---|---|---|---|---|---|
| Mixing | Copper | about 2.5 μm | 60 | 60 | 60 | 60 | 55 |
| Amount | Powder | Flake Powder | | | | | |
| (wt %) | | about 0.3 μm | 15 | 15 | 15 | 15 | 25 |
| | | Spherical Powder | | | | | |
| | | about 7 nm | 10 | — | 10 | 10 | — |
| | | Nano Powder | | | | | |
| | | about 100 nm | — | 8 | — | — | 7 |
| | | Nano Powder | | | | | |
| | Organic | Ethyl cellulose | 0.6 | 0.8 | 0.8 | — | — |
| | Binder | Methylated melamine | 1.2 | — | — | 2 | — |
| | | Butylated melamine | — | 2 | — | — | 2.2 |
| | | Imino methylated | — | — | 1.2 | — | — |
| | | melamine | | | | | |
| | | Acryl resin | 0.6 | 0.8 | — | — | — |
| | Organic | Terpineol | 9.1 | 10.3 | 10 | 10.3 | 9.2 |
| | Solvent | Dihydro terpineol | 3.1 | 2.7 | 2.6 | 2.3 | 1.2 |
| | Additive | Plasticizer | 0.4 | 0.4 | 0.4 | 0.4 | 0.4 |
| Evaluation | Resistivity | 200° C., 1 hr, | 9 | 10 | 12.3 | 13 | 15.6 |
| of Properties | (μΩ · cm) | Reduction Firing | | | | | |
| | Aspect Ratio | Wire Height/Line | 0.31 | 0.32 | 0.30 | 0.30 | 0.28 |
| | | Width after Firing | | | | | |
| | Contact | Evaluation of | 0.68 | 0.68 | 0.77 | 0.89 | 0.75 |
| | Resistance | Solar Cell | | | | | |
| | (mΩ · cm²) | | | | | | |
| | Adhesive Force | Crosscut Test | 0/100 | 0/100 | 0/100 | 0/100 | 0/100 |
| | | (ASTM 3359) | | | | | |

In Table 1, the acryl resin was ethylhexylmethacrylate, and the plasticizer was dioctylphthalate.

### Comparative Examples 1˜5

The components shown in Table 2 below were mixed and dispersed using a 3-roll kneader thus preparing a conductive paste, after which the paste was printed in a line width of about 100 μm on a silicon wafer for a solar cell using a screen printer and then fired at about 200° C. for 1 hour in a reduction atmosphere, followed by evaluating resistivity, contact resistance, aspect ratio and adhesive force. The results are shown in Table 2 below.

TABLE 2

| | | | C. Ex. 1 | C. Ex. 2 | C. Ex. 3 | C. Ex. 4 | C. Ex. 5 |
|---|---|---|---|---|---|---|---|
| Mixing | Copper | about 2.5 μm | 65 | — | 60 | 65 | 65 |
| Amount | Powder | Flake Powder | | | | | |
| (wt %) | | about 0.3 μm | — | 65 | 21 | — | — |
| | | Spherical Powder | | | | | |
| | | about 7 nm | 16 | 16 | — | 20 | 20 |
| | | Nano Powder | | | | | |
| | | about 100 nm | — | — | — | — | — |
| | | Nano Powder | | | | | |
| | Organic | Ethyl cellulose | — | — | — | 0.6 | 0.6 |
| | Binder | Methylated melamine | — | — | — | 2 | — |
| | | Epoxy resin | 2 | — | 2 | — | 2 |
| | | Polyurethane Resin | — | 2 | — | — | — |
| | Curing Agent | Dicyane diamide | 2 | 2 | 2 | — | — |
| | Organic | Terpineol | — | — | — | 10 | 10 |
| | Solvent | Dihydro terpineol | — | — | — | 2.4 | 2.4 |
| | | Ethyl cellosolve | 15 | 15 | 15 | — | — |
| | Additive | Plasticizer | — | — | — | 0.4 | 0.4 |
| Evaluation | Resistivity | 200° C., 1 hr, | 21.6 | 24.3 | 360 | 28.7 | 45 |
| of Properties | (μΩ · cm) | Reduction Firing | | | | | |
| | Aspect | Wire Height/Line | 0.25 | 0.21 | 0.29 | 0.24 | 0.25 |
| | Ratio | Width after Firing | | | | | |
| | Contact | Evaluation of | 1.8 | 1.2 | 3.6 | 1.7 | 2.1 |
| | Resistance | Solar Cell | | | | | |
| | (mΩ · cm²) | | | | | | |
| | Adhesive | Crosscut Test | 0/100 | 32/100 | 10/100 | 16/100 | 18/100 |
| | Force | (ASTM 3359) | | | | | |

In Table 2, the epoxy resin was EA6615 (available from SK Cytec), wherein the equivalent was 1750˜2100 g/eq, the viscosity was 8,000˜9,000 cP (25° C., Rheometer), the solid content was 50%, and Ts was 115˜125° C., and the polyurethane resin was AUP-220 (available from Aekyung Chemical) wherein the weight average molecular weight (Mw) was 15,000, the viscosity was 10,000˜11,000 cP (25° C., Rheometer), the solid content was 50%, and Tg was 45° C. The plasticizer was dioctylphthalate.

As is apparent from Table 1, the pastes comprising flake, spherical and nano particles mixed at an appropriate ratio in Examples 1˜5 enabled the formation of a wire having a high aspect ratio, and could manifest superior electrical properties and high adhesive force. However, in Comparative Examples 1, 4 and 5 of Table 2, the pastes having no spherical particles had low filling density, resulting in low wire thickness and deteriorated electrical properties and adhesive force. Furthermore, in Comparative Examples 2 and 3, the adhesive force was weakened due to the absence of melamine resin. In Comparative Example 3 in which no nano particles were used, the wire thickness was high but low temperature firing properties deteriorated, resulting in very low electrical properties.

In the conductive composition according to the present invention, copper is used as the conductive material, and the melamine-based binder is added, thus enabling the price of a metal wire to decrease and exhibiting superior electrical properties and adhesive force even when conducting low temperature firing. Thereby, the conductive paste composition according to the present invention can be efficiently applied to conductive materials for forming electrodes of a variety of products, including solar cells, touch panels, PCBs, RFID, PDPs, etc.

As described hereinbefore, the present invention provides a conductive paste composition for low temperature firing. According to the present invention, the conductive paste composition includes a copper powder mixture comprising flake copper powder, spherical copper powder and nano copper powder as a conductive material and a melamine-based binder as an organic binder, thus enabling the formation of a conductive wire having a high aspect ratio with high printability and reducing the price of a metal wire. Furthermore, superior electrical properties and adhesive force can be exhibited even when conducting low temperature firing at 200° C. or less. Thereby, the conductive paste composition according to the present invention can be efficiently applied to conductive materials for forming electrodes of a variety of products, including solar cells, touch panels, PCBs, RFID, PDPs, etc.

Although the embodiments of the present invention have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A conductive paste composition for low temperature firing, comprising conductive copper powder comprising flake powder, spherical powder and nano powder, a melamine-based binder, and an organic solvent.

2. The conductive paste composition of claim 1, wherein the composition comprises 50˜95 wt % of the conductive copper powder, 0.01˜5 wt % of the melamine-based binder, and a remainder of the organic solvent.

3. The conductive paste composition of claim 1, wherein the conductive copper powder comprises flake powder having a size of 1˜20 μm, spherical powder having a size of 0.1˜5 μm, and nano powder having a size of 1˜100 nm.

4. The conductive paste composition of claim 1, wherein the conductive copper powder comprises 30˜90 wt % of the flake powder, 5˜60 wt % of the spherical powder, and 1˜30 wt % of the nano powder.

5. The conductive paste composition of claim 3, wherein the conductive copper powder comprises 30˜90 wt % of the flake powder, 5˜60 wt % of the spherical powder, and 1˜30 wt % of the nano powder.

6. The conductive paste composition of claim 1, wherein the flake powder has a ratio of long diameter to short diameter of 1.5˜10.

7. The conductive paste composition of claim 3, wherein the flake powder has a ratio of long diameter to short diameter of 1.5˜10.

8. The conductive paste composition of claim 1, wherein a surface of the nano powder is coated with one or more selected from the group consisting of fatty acid-, amine-, alcohol-, thiol- and polymer-based dispersants.

9. The conductive paste composition of claim 1, wherein the melamine-based binder is one or more selected from the group consisting of methylated melamine, methylated imino melamine, butylated melamine, butylated imino melamine, isobutylated melamine, methyl-butyl mixed melamine, hexamethoxymethyl melamine and urea melamine resin.

10. The conductive paste composition of claim 1, further comprising 0.01˜10 wt % of a cellulose-based binder.

11. The conductive paste composition of claim 10, wherein the cellulose-based binder is one or more selected from the group consisting of ethyl cellulose, methyl cellulose, propyl cellulose, nitro cellulose, acetic acid cellulose, propionic acid cellulose, hydroxyethyl cellulose, hydroxypropyl cellulose, and hydroxyethylhydroxypropyl cellulose.

12. The conductive paste composition of claim 1, further comprising 0.01˜10 wt % of an acrylic binder.

13. The conductive paste composition of claim 12, wherein the acrylic binder is one or more selected from the group consisting of polymethylmethacrylate, ethylhexylmethacrylate, cyclohexylmethacrylate, and butylacrylate.

14. The conductive paste composition of claim 1, wherein the organic solvent is one or more selected from the group consisting of terpineol, dihydroterpineol, ethyl carbitol, butyl carbitol, dihydroterpineol acetate, ethyl carbitol acetate, and butyl carbitol acetate.

15. The conductive paste composition of claim 1, further comprising one or more selected from the group consisting of a plasticizer, a thickener, a dispersant, a thixotropic agent, and a defoaming agent.

16. The conductive paste composition of claim 1, wherein the composition is a conductive material for forming an electrode of a solar cell, a touch panel, a printed circuit board (PCB), radio-frequency identification (RFID), or a plasma display panel (PDP).

17. The conductive paste composition of claim 16, wherein the electrode is formed by using screen printing, gravure printing, dispenser printing, ink-jet printing, dip coating, or spray coating.

18. The conductive paste composition of claim 1, wherein the composition is fired in a temperature range of 100˜200° C.
